(19) United States
(12) Patent Application Publication
(10) Pub. No.: US 2024/0008410 A1
(43) Pub. Date: Jan. 11, 2024

(54) DRAPER

(71) Applicant: CLAAS Hungária Kft., Tõrokszentmiklôs (HU)

(72) Inventors: Christian Füchtling, Rinkerode (DE); Tamás Zelenyánszki, Békéscsaba (HU)

(73) Assignee: CLAAS Hungária Kft., Törökszentmiklós (HU)

(21) Appl. No.: 18/218,156

(22) Filed: Jul. 5, 2023

(30) Foreign Application Priority Data
Jul. 5, 2022 (DE) 10 2022 116 765.8

(51) Int. Cl. A01D 61/02; A01D 61/00

(52) U.S. Cl. CPC A01D 61/02; A01D 61/002

(57) ABSTRACT

A draper is disclosed. The draper includes a frame with a center segment that has at least one endlessly circulating center belt and two side segments each having at least one laterally conveying, endlessly circulating side belt. The draper further includes a flexible cutter bar which is arranged on support arms pivotably articulated on the frame, with the side belts following movement of the flexible cutter bar. A respective side belt has, in the crop intake area adjacent to the cutter bar, a circumferential limiting rib which is overlapped by a belt seal extending substantially over the width of the side segment. The belt seal may be attached to the cutter bar using segmented retaining elements, with the retaining elements exerts a compressive force on the belt seal to press it against the limiting rib.

### CROSS REFERENCE TO RELATED APPLICATION

This application claims priority under 35 U.S.C. § 119 to German Patent Application No. DE 10 2022 116 765.8 filed Jul. 5, 2022, the entire disclosure of which is hereby incorporated by reference herein.

### TECHNICAL FIELD

The present invention relates to a draper according to the preamble of claim 1.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Drapers may include a frame with a center segment having at least one endlessly circulating center belt, two side segments each having at least one laterally conveying, endlessly circulating side belt, and a cutter bar. Seen in the direction of travel, the side belts may be arranged inclined at an angle to the cutter bar. This arrangement results in grains that have detached themselves from the harvested material while picking up same rolling on the side belts towards the front edge of the side belts in the direction of the cutter bar. To prevent these grains from falling from the side belt back to the cutter bar, a trickle protection or a barrier is provided in the area of the front side of the side belt facing the cutter bar. In addition, the front side of the side belt at the transition to the cutter bar is sealed to such an extent that as few grains as possible may get between the cutter bar and the side belt.

U.S. Pat. No. 7,472,533 B2 discloses a draper whose cutter bar has a C-shaped profiled part which encloses the front side of the circulating side belt. In addition, the side belt has a strip of elastic material at its leading edge. Together with the C-shaped profiled part, the strip forms a kind of barrier to stop the grains rolling back in the direction of the cutter bar. In order to ensure that the strip lies flat against the C-shaped profiled part, a frame located in the respective side belt is provided, which holds the crop-conveying belt top in its required position. In order to achieve a seal between the side belt and the C-shaped profiled part, very precise adjustment of these frames is used.

U.S. Pat. No. 7,908,836 B1 discloses a structure comparable to that disclosed in U.S. Pat. No. 7,472,533 B2 and further discloses sealing side belts from the cutter bar on a draper.

U.S. Pat. No. 8,091,330 B2 also discloses a draper. For sealing, a circumferential rib is arranged or positioned on the crop-conveying surface of the respective side belt which is spaced from the front edge of the side belt. The area from the cutter bar to the respective side belt is covered with transition plates.

### BRIEF DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 shows an exemplary and schematic representation of a draper;

FIG. 2 shows an exemplary and schematic partial view of a cutter bar of a side segment of the draper;

FIG. 3 shows an exemplary and schematic view of a partial section of a side belt according to FIG. 2 from diagonally above;

FIG. 4 shows an exemplary and schematic view of a center segment of the draper according to FIG. 1 from above; and

FIG. 5 shows an exemplary and schematic view of a center segment of the draper according to a further embodiment.

### DETAILED DESCRIPTION

As discussed in the background, U.S. Pat. No. 7,472,533 B2 and U.S. Pat. No. 7,908,836 B1 disclose drapers. Each of the solutions disclosed in U.S. Pat. No. 7,472,533 B2 and U.S. Pat. No. 7,908,836 B1, in addition to their complexity and laborious adjustment, also have the limitation that these solutions do not allow use on a draper with a flexible cutter bar and flexible side belts.

Further, U.S. Pat. No. 8,091,330 B2, discussed in the background, teach that the area from the cutter bar to the respective side belt is covered with transition plates. The transition plates in U.S. Pat. No. 8,091,330 B2 extend over the circumferential rib at the leading edge of the respective side belt, wherein a gap of less than 0.6 mm remains between the transition plates and the circumferential rib. To ensure continuous contact, the transition plates exert a contact force directed toward the surface of the side belt which is applied to the rib in an uneven and uncontrolled manner due to the vertical movements of the cutter bar and side belts. Either the exerted contact force is so great that the transition plates lie so heavily on the rib or are pressed against it that the side belt or the surrounding rib is permanently damaged, or the transition plates protrude so far from the rib that the sealing function fails, wherein stalks or stems get between the cutter bar and side belt in addition to harvested material.

Thus, in one or some embodiments, a draper is disclosed that is functionally improved and includes a low-wear seal. This may be achieved by a draper described in more detail below.

In one or some embodiments, a draper is disclosed that includes a frame with a central segment having at least one endlessly circulating central belt and at least two side segments, each having at least one laterally conveying endlessly circulating side belt, and a flexible cutter bar which is arranged or positioned on support arms pivotably articulated on the frame. The side belts may be configured to follow a movement of the flexible cutter bar. In one or some embodiments, the respective side belt has, in the crop intake area adjacent to the cutter bar, a circumferential limiting rib which is overlapped by a belt seal extending substantially over the width of the side segment. Further, the belt seal may be attached to the cutter bar using segmented retaining elements, with the retaining elements exerting a compressive force on the belt seal to press the belt seal against the limiting rib. By being segmented, the retaining elements may follow the movements of the cutter bar by relative movements with respect to immediately adjacent retaining elements. This, in turn, may have the effect that the pressure exerted by the retaining elements on the belt seal is subject to smaller fluctuations. Thus, a more uniform contact pressure may be exerted independently of vertical movements of the flexible cutter bar and correspondingly of the respective side belt. The occurrence of gaps between the belt seal or the retaining elements and the limiting rib may be reduced, which may reduce the risk of crop entering. Furthermore, wear of the limiting rib may be reduced, minimized, or displaced to the belt seal. The latter may be easier and less expensive to replace than a damaged side belt, which may no longer perform its sealing function due to wear.

In one or some embodiments, the belt seal may be made of a flexible material, such as a plastic or rubber. In this way, the wear behavior of the belt seal may be influenced, such as reduced. Likewise, the required elasticity of the belt seal may be obtained or achieved by a suitable choice of material in order to better withstand the dynamically alternating load. In one or some embodiments, the belt seal may be made of a rubber elastic material. The use of a suitable rubber elastic material for the belt seal may allow for reversible deformation of the belt seal. Furthermore, a suitable rubber-elastic material may have the necessary stiffness to transmit the compressive force exerted by the retaining elements to the limiting rib, whereby a surface contact of the belt seal with the limiting rib may be largely maintained.

In one or some embodiments, an overlap-free area formed between the limiting rib and the retaining elements may be covered by the belt seal. The overlap-free area may prevent the belt seal from pressing directly against the limiting rib. Instead, the material property of the belt seal may make it easier to adjust the pressure exerted by the retaining elements.

In one or some embodiments, the limiting rib with the belt seal may form a barrier with a height between 10 mm and 15 mm. Due to the inclination of the respective side belt, harvested material rolling in the direction of the cutter bar may be stopped by this barrier extending in a vertical direction and may accumulate in front of it. Due to the height of this barrier, larger grains may also be stopped in order to be conveyed further sideways, which may reduce grain losses. The vertical barrier formed by the limiting rib and the belt seal may also provide fewer interfering contours for the crop flow.

In one or some embodiments, the limiting rib may have an essentially cuboidal or trapezoidal cross-section. In one or some embodiments, a contact surface is formed on the upper side of the limiting rib facing the belt seal. Seen in the conveying direction, the contact surface may be continuous and may have a substantially planar surface. This may serve to absorb the compressive force applied indirectly by the retaining elements using the belt seal as uniformly as possible.

In one or some embodiments, the respective retaining element may have an inclined front section facing the cutter bar and a substantially parallel rear section facing the side belt, relative to the respective side belt. The retaining elements may be fastened to the cutter bar using their front section. For this purpose, the respective retaining element may be detachably fastened to the cutter bar by a screw connection. Using the rear section of the respective retaining element, the belt seal may be detachably fastened to the retaining elements. This may simplify any necessary replacement of the belt seal. The angle that is enclosed by the front section and the rear section of the respective retaining element may determine the compressive force which is exerted indirectly by the belt seal on the limiting rib.

In one or some embodiments, the retaining elements may be designed as profiled parts made or formed from a metal sheet. In one or some embodiments, these retaining elements may be identical parts, which may be produced in large quantities, for example by laser cutting or punching and subsequent forming processes.

In one or some embodiments, the strip-shaped belt seal having a cuboidal cross-section may be made in one or more parts. In one or some embodiments, the belt seal of each side segment is made in one piece. In particular, the limiting rib and the belt seal may be substantially flush with their vertical end faces on their side facing away from the cutter bar. This may avoid the formation of a butt edge at the transition from the limiting rib to the belt seal.

In one or some embodiments, at least one trough-shaped or arc-shaped catching rib may be arranged or positioned on the surface of the side belts between conveying ribs running perpendicular to the limiting rib and arranged or positioned equidistant to each other, the open side of which faces away from the cutter bar. The trough-shaped or arc-shaped catching ribs may be arranged or positioned to run essentially parallel to the limiting rib. The provision of catching ribs on the crop-conveying surface of the side belts may help to improve trickle protection. The trough-shaped or arc-shaped catching ribs may stop grains falling onto the side belt in the area where the catching ribs are arranged or positioned. Furthermore, rolling grains may be slowed down by the catching ribs so that they do not roll back to the cutter bar at such a high speed that they jump in certain circumstances over the vertical barrier consisting of the limiting rib and belt seal. In this way, losses in the area of the side belts may be specifically avoided.

In particular, the catching ribs arranged or positioned in at least one row may be arranged or positioned at a distance from the limiting rib so that the catching ribs are always located in the intake area of the at least one center belt. This may be particularly advantageous because the at least one center belt is at a greater distance from the cutter bar than the side belts. This may reduce the risk of losses in the area of the center segment to a minimum. The position of the trough-shaped or arc-shaped catching ribs is specifically aligned with the center belt so that the grains retained by the catching ribs are conveyed onto the center belt and are not discharged in the area between the cutter bar and the center belt in which the center belt cannot pick up the grains because of the distance from the cutter bar.

For this purpose, the trough-shaped or arc-shaped catching ribs, starting from the cutter bar, may be arranged or positioned above the lower third of the side belt. In this way, the grains falling onto the belt may be specifically held in the upper and middle area of the side belt.

Furthermore, the catching ribs may extend essentially to the conveying ribs. This may mean that only small lateral gaps remain between the end regions of the respective trough-shaped or arc-shaped catching ribs and the conveyor ribs adjacent thereto.

In one or some embodiments, the center segment may have at least one center belt which is oriented perpendicular to the conveying direction of the side belts.

Alternatively, the center segment may have two center belts arranged or positioned next to each other in a V-shape and converging toward each other as viewed in their conveying direction.

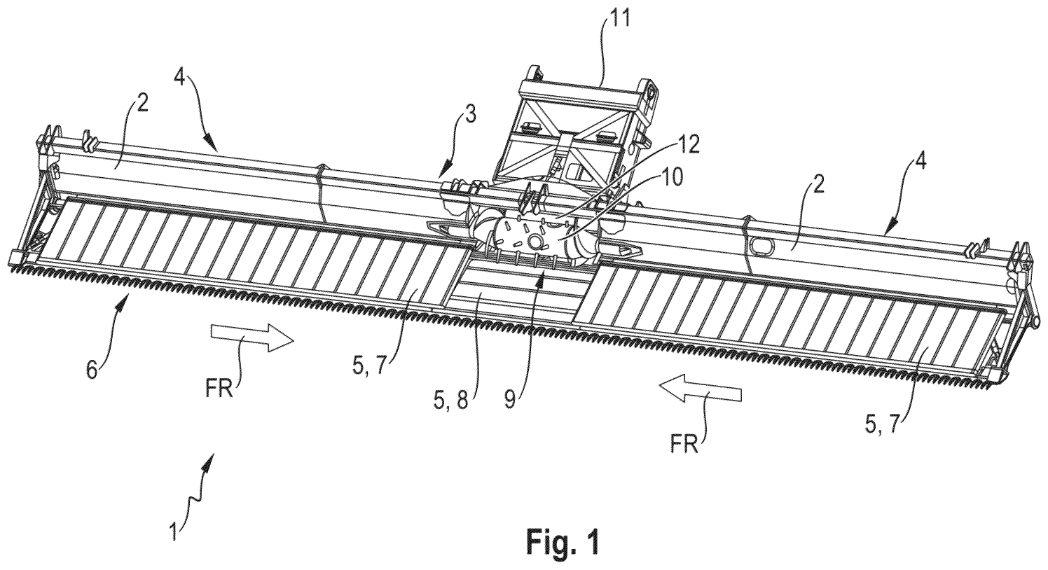

Referring to the figures, FIG. 1 shows an exemplary and schematic representation of a draper 1. Various types of drapers are contemplated, such as disclosed in US Patent Application Publication No. 2023/0099974A1, US Patent Application Publication No. 2022/0304235A1, and US Patent Application Publication No. 2008/0276591A1, each of which are incorporated by reference herein in their entirety. The draper 1 may comprise a center segment 3 and at least two side segments 4 arranged or positioned adjacent to the center segment 3. The draper 1 has a frame 2. In one or some embodiments, the frame 2 may be designed segmented. In such a case, the center segment 3 and the side segments 4 may each have individual frame segments on which they are arranged or positioned. The frame segments may together form the segmented frame 2. Two outer frame segments may be pivotally arranged or positioned on an inner frame segment.

A ground-copying flexible cutter bar 6 may be arranged or positioned on the center segment 3 and the side segments 4 on the front side of the draper 1 opposite the frame 2, which may extend substantially over the entire width of the draper 1. The flexible cutter bar 6, which may be arranged or positioned on support arms pivotably articulated to the frame 2, may undergo deflection in the vertical direction about a horizontal position due to unevenness of the ground. In this case, the flexible cutter bar 6 may be deflected in a positive direction upwards away from the ground and in a negative direction downwards towards the ground.

The harvested material cut by the cutter bar 6 may be fed to a conveying device 5 arranged or positioned behind the cutter bar 6, which may be designed as at least one endlessly circulating side belt 7 on the respective side segments 4. The endlessly circulating side belts 7 of the side segments 4 may each be arranged or positioned adjacent to the center segment 3 in order to transport harvested material cut by the cutter bar 6 sideways in a conveying direction FR to the center segment 3 and to feed it to a feed device 9. The side belts 7 may be set up to follow a movement of the flexible cutter bar 6.

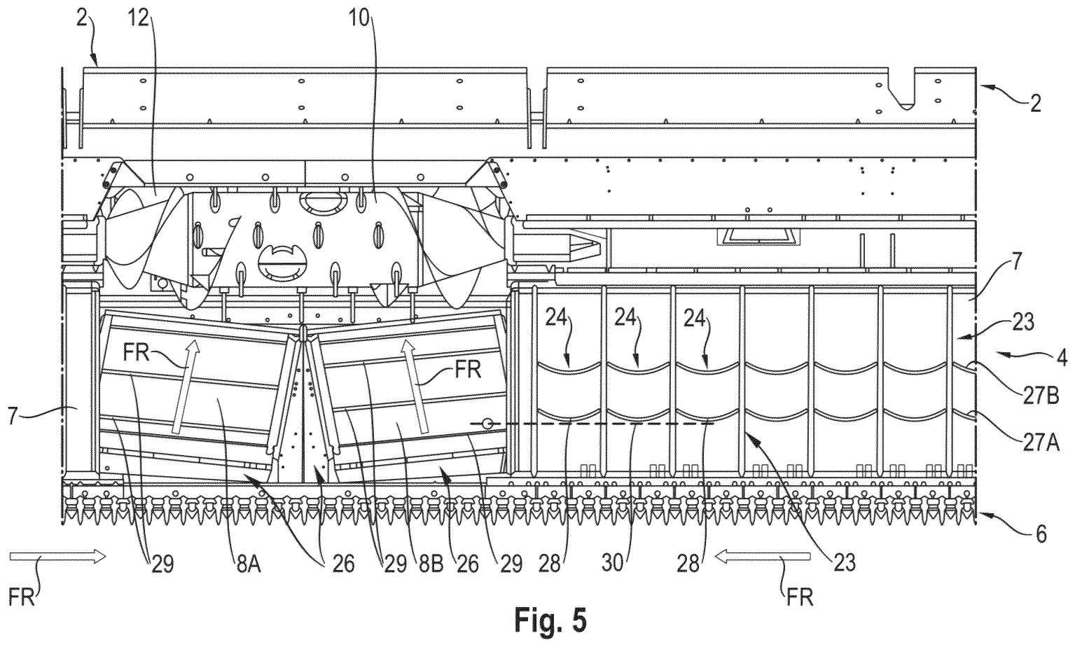

The center segment 3 may also comprise a conveying device 5 designed as at least one endlessly circulating center belt 8. The at least one center belt 8 of the center segment 3 may convey transversely to the conveying direction FR of the side belts 7 of the side segments 4. Other designs of the conveying device 5 in the area of the center segment 3 are contemplated, as will be explained further below with reference to an embodiment shown in FIG. 5. The feed device 9 may be designed as a drivable feed roller 10. The feed device 9 feeds the harvested material, which may be fed laterally to the center segment 3 by the endlessly circulating side belts 7, to an opening 12, which may be provided in the frame 2 of the center segment 3 and may be located behind the feed roller 10 and through which the picked-up harvested material may be fed to the combine for further processing through a feed channel 11, which may be located on a combine (not shown) and to which the draper 1 may be detachably attached.

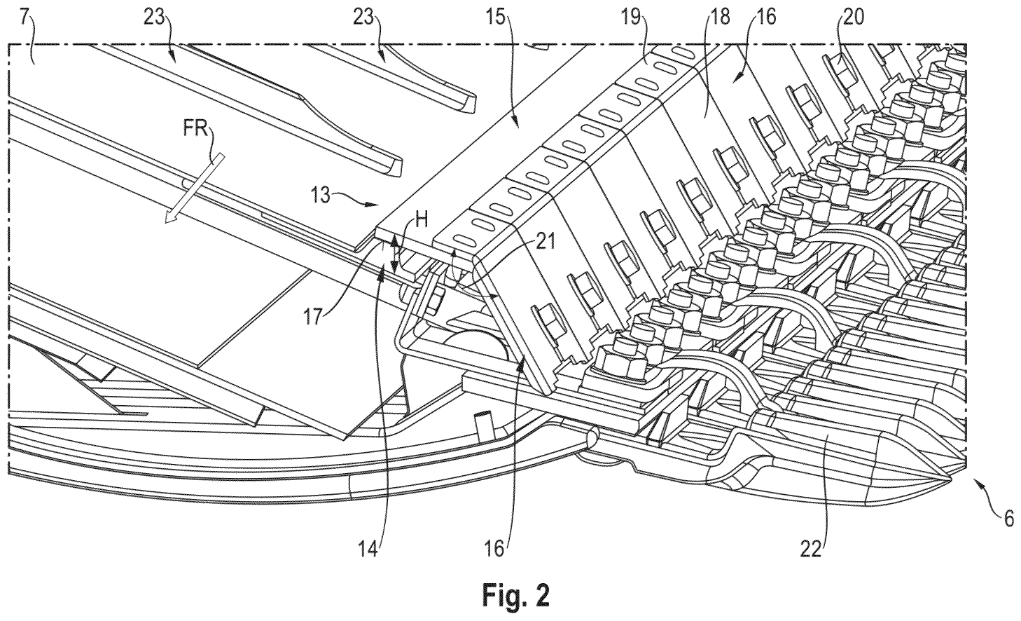

FIG. 2 shows an exemplary and schematic partial view of a cutter bar 6 of one of the side segments 4 of the draper 1. In one or some embodiments, the side segments 4 are of identical design so that the following explanations apply to both side segments 4.

In one or some embodiments, the respective side belt 7 has a circumferential limiting rib 14 in the crop intake area 13 adjacent to the cutter bar 6, which may run parallel to the cutter bar 6. The limiting rib 14 may be arranged or positioned on the crop-conveying upper side of the side belt 7. The limiting rib 14 may be overlapped by a belt seal 15 extending substantially across the width of the side segment 4. The belt seal 15 may be attached to the cutter bar 6 using one or more segmented retaining elements 16. In one or some embodiments, the limiting rib 14 has a substantially cuboidal or trapezoidal cross-section. This therefore may form a contact surface 17 parallel to the crop-conveying upper side of the side belt 7. The contact surface 17 may be continuous, as viewed in the conveying direction FR, and may have a substantially planar surface. The retaining elements 16 may exert a compressive force on the belt seal 15 to press the belt seal against the contact surface 17 on the upper side of the limiting rib 14.

The belt seal 15 may comprise (or consists of) a flexible material, such as a plastic or rubber. In this way, the wear behavior of the belt seal 15 may be influenced or affected. Likewise, the desired elasticity of the belt seal 15 may be provided by a suitable choice of material in order to better withstand the dynamically alternating load. In one or some embodiments, the belt seal 15 may be made of a rubber elastic material. The use of a suitable rubber elastic material for the belt seal may allow reversible deformation of the belt seal 15. Furthermore, a suitable rubber-elastic material may have the necessary stiffness to transmit the compressive force exerted by the retaining elements to the limiting rib, whereby the surface contact of the belt seal 15 with the limiting rib 14 may be largely maintained.

In one or some embodiments, the limiting rib with the belt seal 15 forms a barrier with a height between 10 mm and 15 mm. This may mean that larger grains, for example corn kernels, beans or the like, may also be stopped by the barrier.

The respective retaining element 16 may have an inclined front section facing the cutter bar 6 and a substantially parallel rear section 19 facing the side belt 7, relative to the respective side belt 7. The respective retaining element 16 may be detachably fastened to the cutter bar 6 using a screw connection 20. Using the rear section 19 of the respective retaining element 16, the belt seal 15 may be detachably fastened to the retaining elements 16. The belt seal 15 may be arranged or positioned on the underside of the rear section 19 of the retaining elements 16 facing the side belt 7. In one or some embodiments, this may also be done using a threaded connection. This may simplify any necessary replacement of the belt seal 15 due to wear. An angle 21 that is enclosed by the front section and the rear section 19 of the respective retaining element may determine the compressive force which is exerted indirectly by the belt seal 15 on the contact surface 17 of the limiting rib 14.

In one or some embodiments, an overlap-free area formed between the limiting rib 14 and the retaining elements 16 is covered by the belt seal 15. The overlap-free area may be formed between the end face of the rear section 19 of the respective retaining element 16 and the contact surface 17 of the limiting rib 14. Therefore, no direct compressive force may be exerted by the retaining elements 16 on the limiting rib 14, as may be the case in other drapers. A significant effect is that wear may essentially be shifted to the belt seal 15. Due to the elasticity of the belt seal 15, the gap formation between that of the limiting rib 14 and the belt seal 15 may be reduced or minimized when a sectional vertical deflection of the cutter bar 6 and the side belt 7 results in a substantially arcuate deformation, the movement of which may be transmitted to the retaining elements 16.

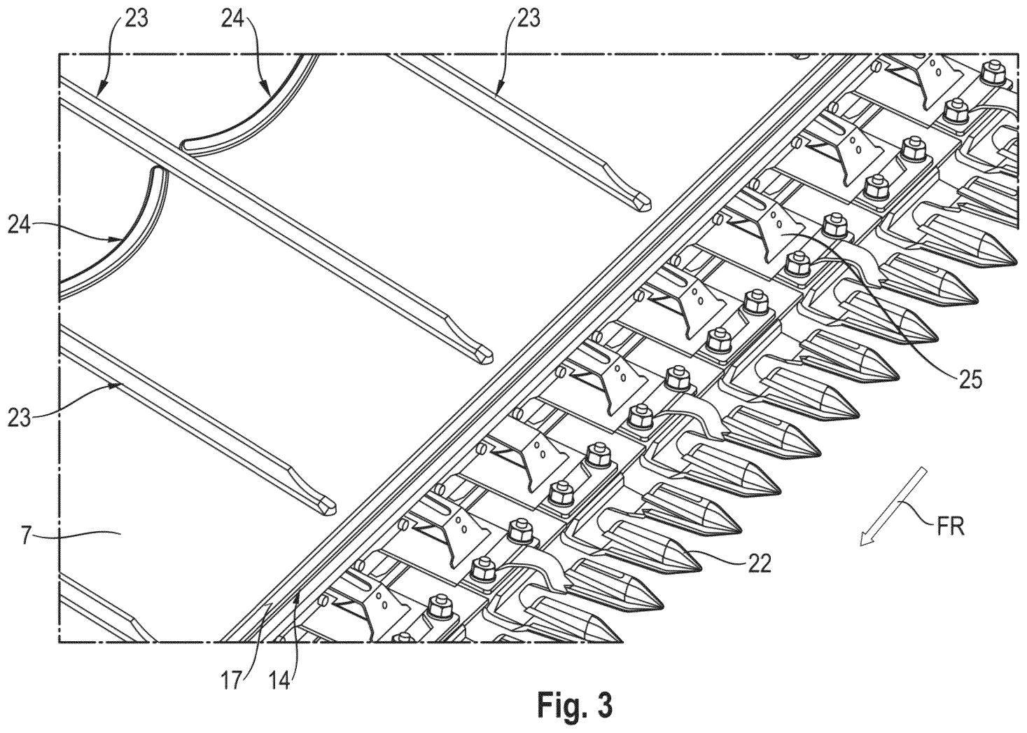

In one or some embodiments, the segmented retaining elements 16 may execute a relative movement to each other initiated by a vertical movement of the cutter bar 6 about an axis running perpendicular to the cutter bar 6. For this purpose, a retaining element 16 may be assigned to each blade finger 22 arranged or positioned on the cutter bar 6. In the present embodiment of the cutter bar, the blade fingers 22 are designed as double fingers, as may be seen in FIG. 3.

In one or some embodiments, the retaining elements 16 are designed in particular as profiled parts made from a metal sheet. This enables the retaining elements 16 to be manufactured cost-effectively in large quantities.

The strip-shaped belt seal 15, which may have a cuboidal cross-section, may be made of one or more parts. The belt seal 15 may therefore extend as a single element completely over the width of a side segment 4 or comprise (or consist of) two or more single elements arranged or positioned next to each other on the retaining elements 16.

In one or some embodiments, conveying ribs 23 running perpendicularly to the limiting rib 14 and arranged or positioned equidistantly to one another are arranged or positioned on the crop-conveying surface of the side belts 7. The conveying ribs 23 may extend as far as the crop intake area 13 and end in front of the limiting rib 14 at a distance therefrom. At least one trough-shaped or arc-shaped catching rib 24 may be arranged or positioned between each of the conveying ribs 23, the open side of which faces away from the cutter bar 6, as shown in FIGS. 3 to 5.

The illustration in FIG. 3 shows an exemplary and schematic view of a partial section of the side belt according to FIG. 2 diagonally from above. The illustration shows the partial section of the side belt 7 without the retaining elements 16 as well as the belt seal 15 arranged or positioned thereon. Angled fastening plates 25 may be seen which may serve to detachably receive the retaining elements 16 that are arranged or positioned in the area between the side belt 7 and the blade fingers 22 on the cutter bar 6.

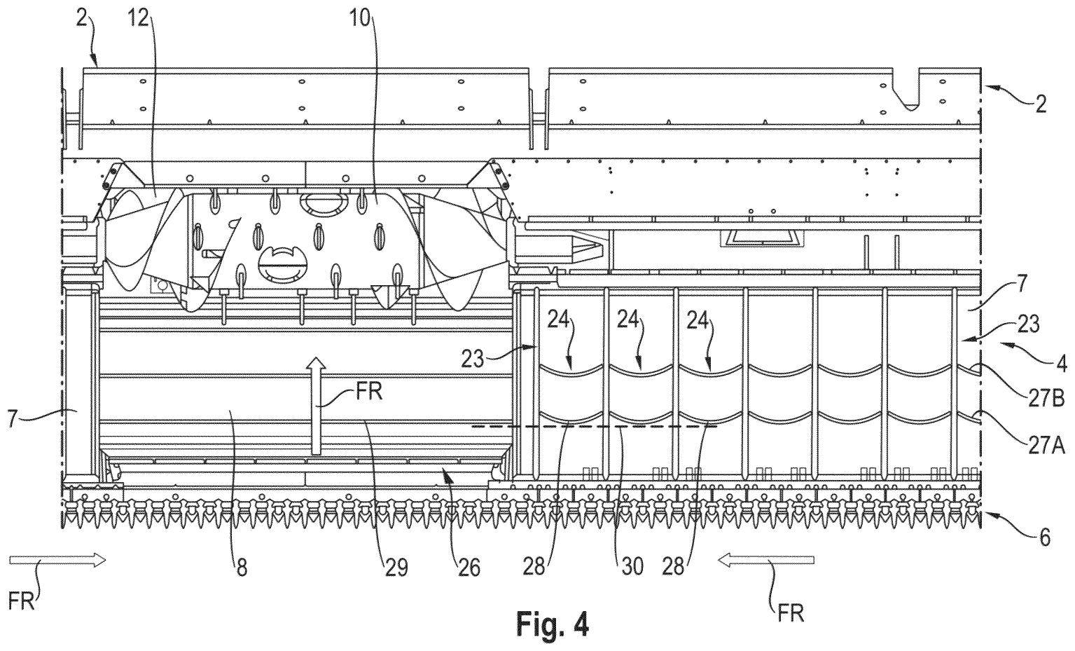

FIG. 4 shows an exemplary and schematic view of the center segment 3 of the draper 1 according to FIG. 1 from above. The center belt 8 of the center segment 3 may convey transversely to the conveying direction FR of the side belts 7 toward the feed roller 10. In contrast to the side belts 7 which, with their front edge on which the limiting rib 14 is arranged or positioned, are almost directly adjacent to the cutter bar 6, the front edge of the center belt 8 has a greater distance to the cutter bar 6. Due to the greater distance of the center belt 8 from the cutter bar 6 compared to the side belts 7, an area 26 is formed at the ends of the side belts 7 facing the center belt 8, in which the harvested material is fed to the center belt 8 in front of the latter. Like the side belts 7, the center belt 8 has equidistantly arranged or positioned conveying ribs 29 which, however, may be arranged or positioned running parallel to the cutter bar 6 on the center belt 8. In this area 26, crop guide plates or the like may be arranged or positioned which serve to passively feed the harvested material to the center belt 8.

As previously explained with reference to FIG. 3, at least one trough-shaped or arc-shaped catching rib 24 may be arranged or positioned between each of the conveying ribs 23, and its open side faces away from the cutter bar 6. The catching ribs 24 may be arranged or positioned in at least one row 27A, 27B next to each other on the harvested material-conveying surface of the respective side belt 7. The catching ribs 24 arranged or positioned side by side in a row 27A, 27B may be arranged or positioned at a distance from the limiting rib 14, so that the catching ribs 24 are always located in the intake area of the at least one center belt 8. The intake area may be the area of the center belt 8 in which the respective side belt 7 spatially overlaps the center belt 8 so that the harvested material passes directly from the respective side belt 7 onto the center belt 8.

In one or some embodiments, two rows 27A, 27B are arranged or positioned running parallel to each other on the crop-conveying surface of the side belts 7.

Due to their shape, the trough-shaped or arc-shaped catching ribs 24 may have a lowest point 28 in which the stopped grains may collect. In one or some embodiments, the spacing of the row 27A with catching ribs 24, which is arranged or positioned closest to the cutter bar 6 on the side belts 7, may be selected in such a way that the lowest point 28 of the catching ribs 24 may always be above the respective conveyor rib 29 which passes the row 27A with catching ribs 24 closest to the cutter bar 6. This may allow grains stopped by the catching ribs 24 to always reach the center belt 8 above a conveying rib 29. This is illustrated by a dashed line 30, which is drawn starting from the lowest point 28 of the catching rib 24 of row 27A to the center belt 8.

In one or some embodiments, the catching ribs 24, starting from the cutter bar 6, may be arranged or positioned above the lower third of the respective side belt 7. Another aspect is that the catching ribs 24 may extend essentially up to the conveyor ribs 23 running perpendicular thereto.

FIG. 5 shows an exemplary and schematic view of the center segment 3 of the draper 1 according to another embodiment. The center segment 3 differs only in the design of the conveying device 5. The center segment 3 has two center belts 8A, 8B arranged or positioned side by side in a V-shape which, viewed in their respective conveying direction FR, are arranged or positioned to converge towards each other. The embodiment of the side belts 7 corresponds to that described above.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Draper
2 Frame
3 Middle segment
4 Side segment
5 Conveying device
6 Cutter bar
7 Side belt
8 Central belt
8A Central belt
8B Central belt
9 Feed device
10 Feed roller
11 Feed channel
12 Opening
13 Crop intake area
14 Limiting rib
15 Belt seal
16 Retaining element
17 Contact surface
18 Front section
19 Rear section
20 Threaded connection
21 Angle
22 Blade finger
23 Conveying rib
24 Catching rib
25 Fastening plate
26 Area
27A Row
27B Row
28 Lowest point of 24
29 Conveying rib
30 Line

1. A draper comprising:
a frame with a center segment having at least one endlessly circulating center belt and two side segments each having at least one laterally conveying, endlessly circulating side belt; and
a flexible cutter bar positioned on one or more support arms pivotably articulated on the frame, wherein the side belts are configured to follow a movement of the flexible cutter bar;
wherein a respective side belt has, in a crop intake area adjacent to the flexible cutter bar, a circumferential limiting rib which is overlapped by a belt seal extending substantially over a width of a respective side segment;
wherein the belt seal is attached to the cutter bar using one or more segmented retaining elements; and
wherein the one or more segmented retaining elements are configured to exert a compressive force on the belt seal to press the belt seal against the circumferential limiting rib.

2. The draper of claim 1, wherein the belt seal consists of a flexible material.

3. The draper of claim 2, wherein the belt seal consists of plastic or rubber.

4. The draper of claim 1, wherein an overlap-free area formed between the circumferential limiting rib and the one or more segmented retaining elements is covered by the belt seal.

5. The draper of claim 1, wherein the circumferential limiting rib with the belt seal forms a barrier with a height between 10 mm and 15 mm.

6. The draper of claim 1, wherein the circumferential limiting rib has a substantially cuboidal or trapezoidal cross-section.

7. The draper of claim 6, wherein the circumferential limiting rib is configured to form a contact surface parallel to a crop-conveying upper side of the respective side belt.

8. The draper of claim 7, wherein the contact surface is continuous, as viewed in a conveying direction, and is a substantially planar surface.

9. The draper of claim 7, wherein the one or more segmented retaining elements are configured to exert a compressive force on the belt seal to press the belt seal against the contact surface on an upper side of the circumferential limiting rib.

10. The draper of claim 1, wherein a respective retaining element has an inclined front section facing the flexible cutter bar and a substantially parallel rear section facing the respective side belt, relative to the respective side belt.

11. The draper of claim 10, wherein the one or more segmented retaining elements comprise profiled parts formed from a metal sheet.

12. The draper of claim 1, wherein the belt seal is strip-shaped and has a cuboidal cross-section; and
wherein the belt seal is composed of one or more parts.

13. The draper of claim 1, further comprising at least one trough-shaped or arc-shaped catching rib positioned on a surface of the respective side belt between conveying ribs running perpendicular to the circumferential limiting rib and positioned equidistant to each other, an open side of which faces away from the cutter bar.

14. The draper of claim 13, wherein a plurality of the catching ribs are positioned side-by-side in at least one row at a distance from the circumferential limiting rib, so that the plurality of catching ribs are always located in the crop intake area of the at least one center belt.

15. The draper of claim 13, wherein the catching ribs, starting from the cutter bar, are positioned above a lower third of a respective side belt.

16. The draper of claim 13, wherein the catching ribs extend substantially to the conveying ribs.

17. The draper of claim 1, wherein the center segment has at least one center belt which is oriented perpendicular to a conveying direction of the side belts.

18. The draper of claim 1, wherein the center segment has two center belts positioned side by side in a V-shape which, viewed in their conveying direction, are positioned to converge towards each other.

19. The draper of claim 1, wherein the circumferential limiting rib in the crop intake area runs parallel to the cutter bar.

20. The draper of claim 1, wherein a respective retaining element has an inclined front section facing the cutter bar and a substantially parallel rear section facing a respective side belt, relative to the respective side belt.
